(19) United States
(12) Patent Application Publication
(10) Pub. No.: US 2006/0225688 A1
(43) Pub. Date: Oct. 12, 2006

(54) Engine bore liner cassette and method

(76) Inventors: Gary C. Ward, Saline, MI (US); Bob R. Powell JR., Birmingham, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/099,883

(22) Filed: Apr. 6, 2005

(51) Int. Cl. F02F 1/00

(52) U.S. Cl. 123/193.2

(57) ABSTRACT

Cast-in-place cylinder bore liners are disclosed for use in casting of engine cylinder blocks, wherein a plurality of the cylinder bore liners are joined to form a cassette, and wherein an accuracy in positioning of each of the bore liners with respect to each other is maximized and a weight thereof is minimized.

### FIELD OF THE INVENTION

The invention relates to cylinder bore liners, and more particularly to cast-in-place cylinder bore liners for use in casting of engine cylinder blocks, wherein a plurality of the cylinder bore liners are joined to form a cassette.

### BACKGROUND OF THE INVENTION

Typically, aluminum die cast engine cylinder blocks are produced with cast-in-place bore liners. Many known bore liners are produced from cast iron since wear resistance is high and wear resistance for aluminum alloys used to form engine blocks is low.

In the manufacture of an aluminum engine with cast-in-place bore liners, for example, a mold assembly method typically involves positioning a base core on a suitable surface and building up or stacking separate mold elements to shape such casting features as sides, ends, valley, water jacket, cam openings, and crankcase. The bore liners are positioned on barrel cores such that the liners become embedded in a casting after molten metal is poured into the mold. Additional cores may be present as well depending on the engine design. Various designs for the barrel cores are used in the industry. These include individual barrel cores, “V” pairs of barrel cores, barrel-slab cores, and integral barrel crankcase cores.

The engine block casting must be machined in a manner to ensure, among other things, that the cylinder bores (formed from the bore liners) have uniform bore liner wall thickness, and that other critical block features are accurately machined. This requires the liners to be accurately positioned relative to one another within the casting. It is also required that the block is optimally positioned relative to the machining equipment.

It would be desirable to produce a bore liner cassette wherein an accuracy in positioning of each of the bore liners with respect to the other bore liners is maximized and a weight thereof is minimized.

### SUMMARY OF THE INVENTION

Consistent and consonant with the present invention, a bore liner cassette wherein an accuracy in positioning of each of the bore liners with respect to the other bore liners is maximized and a weight thereof is minimized, has surprisingly been discovered.

In one embodiment, the bore liner cassette comprises at least one hollow cylinder bore liner adapted to be cast into an engine cylinder block to form a piston cylinder therein, an inner wall of the bore liner having a substantially circular cross section and a substantially uniform diameter, the cylinder bore liner formed from an aluminum alloy consisting essentially of, by weight, less than 14% silicon; about 2.0 to 2.5% copper; about 0.25 to 0.35% magnesium; about 0.4 to 0.5% iron; about 0.5 to 0.73% manganese; about 0.015 to 0.03% strontium; about 0.1 to 0.25% titanium; and a balance of aluminum, wherein the weight ratio of manganese to iron is about 1.25 to 1.45.

In another embodiment, the bore liner cassette comprises a plurality of hollow cylinder bore liners joined at a bridge area, the bore liners adapted to be cast into an engine cylinder block to form a plurality of piston cylinders therein, an inner wall of each of the bore liners having a substantially circular cross section and a substantially uniform diameter, the cylinder bore liners formed from an aluminum alloy comprising, by weight, less than 14% silicon; about 2.0 to 2.5% copper; about 0.25 to 0.35% magnesium; about 0.4 to 0.5% iron; about 0.5 to 0.73% manganese; about 0.015 to 0.03% strontium; about 0.1 to 0.25% titanium; and a balance of aluminum, wherein the weight ratio of manganese to iron is about 1.25 to 1.45.

The invention also provides methods for forming a bore liner cassette.

In one embodiment, the method of forming a bore liner cassette comprises the steps of providing an aluminum alloy comprising, by weight, less than 14% silicon; about 2.0 to 2.5% copper; about 0.25 to 0.35% magnesium; about 0.4 to 0.5% iron; about 0.5 to 0.73% manganese; about 0.015 to 0.03% strontium; about 0.1 to 0.25% titanium; and a balance of aluminum, wherein the weight ratio of manganese to iron is about 1.25 to 1.45; and casting the cylinder bore liner cassette with the aluminum alloy, the bore liner cassette including a plurality of hollow cylinder bore liners joined at a bridge area, the bore liners adapted to be cast into an engine cylinder block to form a plurality of piston cylinders therein

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a side perspective view of a bore liner cassette according to an embodiment of the invention;

FIG. 2 is an exploded schematic view of an engine cylinder block die for casting a cylinder block of an engine including the bore liner cassette illustrated in FIG. 1;

FIG. 3 is a perspective view of a six cylinder V-type engine cylinder block incorporating the bore liner cassette illustrated in FIGS. 1 and 2;

FIG. 4 is a schematic sectional view of a cylinder bore liner of a wet type; and

FIG. 5 is a schematic sectional view of a cylinder bore liner of a dry type.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

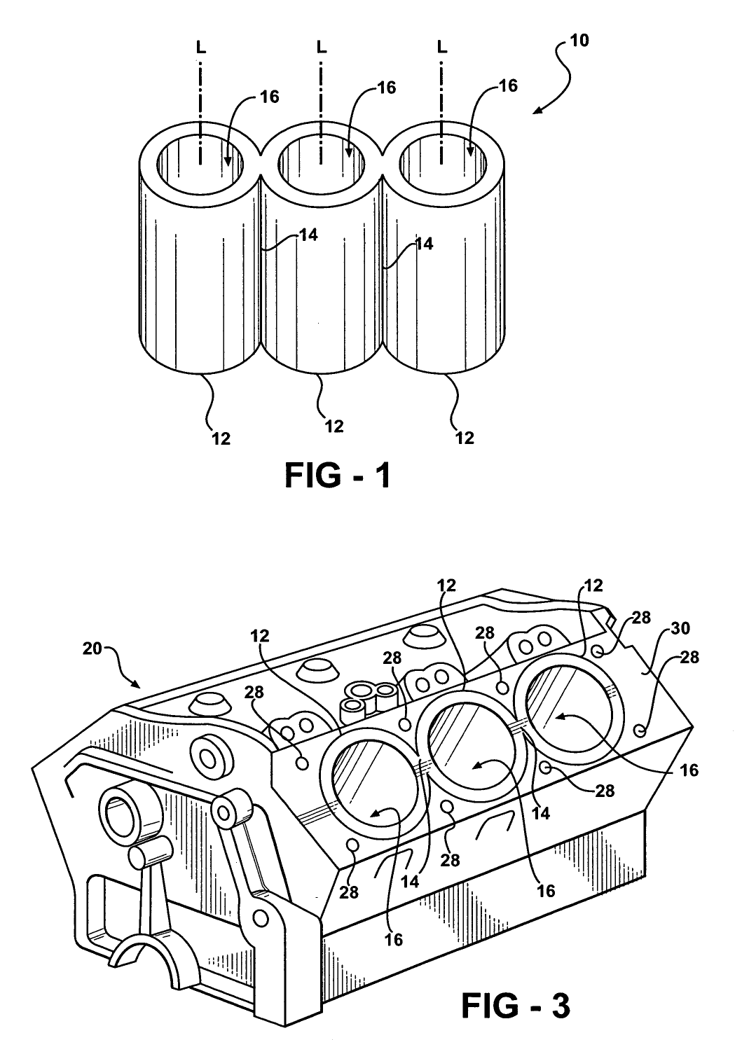

FIG. 1 illustrates a bore liner cassette 10 according to an embodiment of the invention. As used herein, cassette means a receptacle, a cartridge, a cylinder, and a joined plurality of a receptacle, a cartridge, or a cylinder, for example. In one embodiment, the bore liner cassette 10 is cast using high pressure die casting. Any conventional casting method such as casting with permanent or semi-permanent molds, for example, can be used without departing from the scope and spirit of the invention.

In the embodiment shown, the bore liner cassette 10 includes three bore liners 12. The three bore liners 12 are shown for illustrative purposes only, as more or fewer bore liners 12 can be used as desired. Each of the bore liners 12 are joined with at least one other bore liner 12 at a bridge area 14. A longitudinal axis L of the bore liners 12 is substantially aligned with the longitudinal axis L of each of the other bore liners 12. Aligned as used herein means that the longitudinal axes L of the bore liners 12 are substantially parallel to one another and arranged substantially linearly in a transverse direction. Although the bridge area 14 is shown extending the entire length of the bore liners 12, it is understood that the bridge area 14 can be formed over only a portion of the length of the bore liners 12, or that a plurality of bridge areas 14 can be used between adjacent bore liners 12, as desired. Each of the bore liners 12 is hollow having a longitudinally extending aperture 16 formed therein.

The bore liner cassette 10 according to an embodiment of the invention is produced from an aluminum alloy. The aluminum alloy can be that disclosed in commonly owned U.S. Pat. Appl. Pub. No. 2004/0265163, for example, hereby incorporated herein by reference in its entirety.

Surprisingly favorable results have also been found using an aluminum alloy having element concentrations in the following ranges: a silicon content of less than 14 percent, typically about 10.75 percent to 11.25 percent, with a target of 11 percent; copper is typically in the range of about 2 to 2.5 percent, with a target of 2.25 percent; a range of about 0.25 to 0.35 percent of magnesium is preferable, with a target of 0.3 percent; iron is typically between about 0.4 and 0.5 percent, with a target of 0.45 percent; manganese is in the range of about 0.5 to 0.73 percent, with a target of 0.58 percent; strontium is typically between about 0.015 percent and 0.030 percent with a target of 0.022 percent; and a maximum value of 0.25 percent is provided for titanium, with a low range point of about 0.10 percent and a target of 0.15 percent. A desired ratio of manganese to iron is in the range of about 1.25 to 1.45, with a target of 1.35. Any other elements present, such as incidental impurities, are desired to be present at a concentration less than or equal to about 0.05 percent. However, any calcium or phosphorus present is desired to be less than 0.04 percent. The balance of the alloy is aluminum, except for incidental impurities. Incidental impurities as used herein also includes elements which may be present in one or more of the constituents of the aluminum alloy.

A castable melt is typically prepared by melting aluminum ingot with suitable aluminum based master alloys such as Al-25 Fe, Al-50 Cu, Al-20 Mn, Al-50 Si and pure magnesium metal to a desired composition as described above. It is understood that other processes can be used to produce the castable melt without departing from the scope and spirit of the invention. Rare earth additions are made via a mischmetal master alloy or as pure metals or as rare earth aluminum master alloys. Such additions can be made to the initial charge. However, it is preferred that the additions are made after the melt has been treated with a flux and/or degassed, if such processing is used.

The melt is prepared in a suitable furnace such as a coreless induction furnace, electric resistance furnace, reverberatory furnace, or a gas-fired crucible furnace of clay-graphite or silicon carbide, for example. A flux is required only with dirty or drossy charge materials. Usually no special furnace atmosphere is necessary. The heats can be melted in ambient air. Once molten, the melt is degassed using common aluminum foundry practice, such as purging the melt with dry argon or nitrogen through a rotary degasser. The degassing operation can also contain a halogen gas, such as chlorine or fluorine or halogen salts to facilitate impurity removal. Preferably the melt is handled in a quiescent manner so as to minimize turbulence and hydrogen gas pick-up.

Once degassed and cleaned the metal is treated with strontium or a rare-earth mischmetal to affect eutectic silicon modification. The preferred method is to use Al-10 Sr or Al-90 Sr master alloys, plunged into the metal during the last stages of degassing, provided no halogen material is used. The gas level of the melt is assessed via any of the common commercially available methods, such as the reduced pressure test or an A1SCAN.™. instrument.

Melt superheat has been varied from less than 150 degrees Fahrenheit, to well over 700 degrees Fahrenheit with success. It is desirable to cast the cylinder bore liner cassettes 10 from the subject alloys at a pouring temperature from about 1170 degrees Fahrenheit to about 1250 degrees Fahrenheit. Pouring temperatures of about 1170 degrees Fahrenheit to 1200 degrees Fahrenheit are preferred. Lower levels of superheat are recommended to minimize micro-porosity. However, higher levels of superheat have resulted in a refinement of the intermetallics in the microstructure. Thus, under some circumstances, this method may be used.

In the embodiment described herein, high pressure die casting is used. However, the metal can be poured into a suitable mold that has been made by any of a number of known mold making practices, such as bonded sand molds, metal or permanent molds or investment mold making. Sand molds can contain metal chills to facilitate directional solidification or to refine the microstructure of the casting if desired.

Cylinder bore liner cassettes 10 of the present invention can be heat treated to enhance the mechanical properties by known precipitation hardening mechanisms for aluminum alloys. For example, a T5 temper consists of artificially aging the casting at an intermediate temperature, typically from 300 to 450 degrees Fahrenheit, for up to 12 hours or more.

More demanding casting applications may require the peak strength T6 temper which consists of a solution treatment at a temperature near, but less than the alloy solidus temperature, for times typically ranging from 4 to 12 hours, but could be more or less depending on the initial stage of the microstructure in the casting. The casting is quenched from the solution temperature in a suitable quenchant fluid such as water, oil or polymer, or rapidly moving air. Such quenching rapidly cools the heat treated casting through the critical temperature regime, usually 850 to 450 degrees Fahrenheit. Once cooled, the casting usually resides at room temperature for 1 hour to 24 hours and is then reheated to an intermediate temperature, similar to the T5 temper.

In applications where dimensional stability is of utmost importance, the T7 temper will be specified. This is similar to the T6 temper, except that the artificial aging cycle is either done at higher temperatures or longer times or both to achieve a somewhat softer condition, but with greater dimensional stability. The cylinder bore liner cassette casting is now ready to be machined.

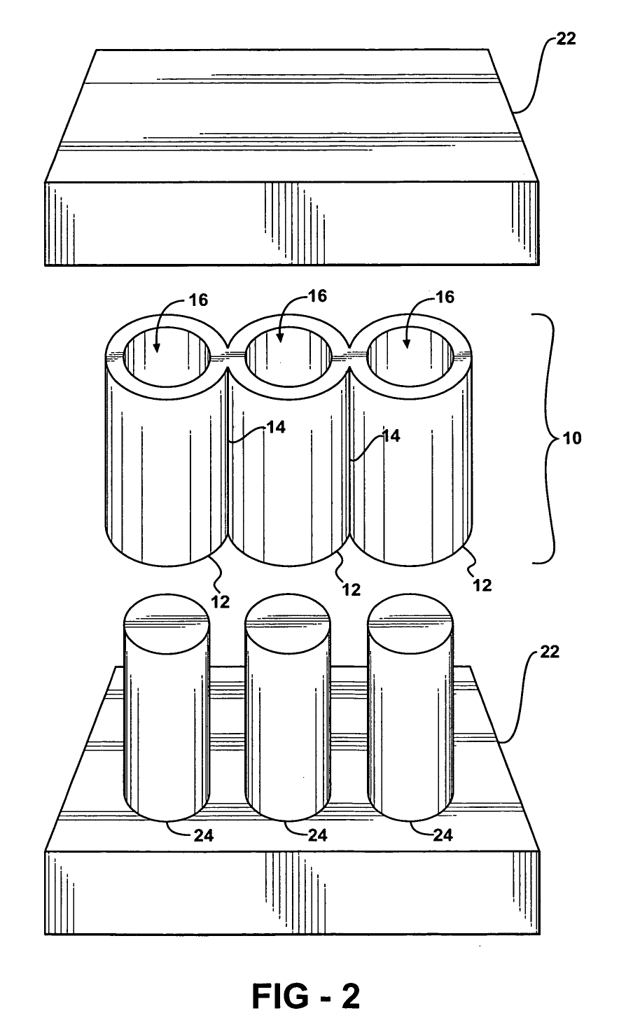

To form a cylinder block 20 of an engine as illustrated in FIG. 3, the bore liner cassette 10 is disposed in an engine cylinder block die 22, as shown in FIG. 2. A mandrel 24 of the die 22 is provided for each of the bore liners 12 and receives the bore liner 12 thereon. The mandrel 24 is inserted into the aperture 16 of each of a respective one of the bore liners 12. The casting of the engine cylinder block 20 is accomplished using any conventional casting process.

As illustrated in FIG. 3, the bore liner cassette 10 is molded into the engine cylinder block 20. The aperture 16 of each of the cylinder bore liners 12 forms a single cylinder of the engine cylinder block 20. Only three of the six cylinders, or one branch of the “V” in the V-6 engine cylinder block 20 are visible in FIG. 3. The engine cylinder block 20 casting typically requires considerable machining. For example, a large number of bolt holes 28 for attachment of cylinder heads (not shown) must be drilled and threaded. The plane bulkhead surface 30 against which the cylinder head lies must be machined. The walls of each of the cylinder bore liners 12 must also be machine finished. Additional machining operations are required to complete production of the engine cylinder block 20 for assembly into a vehicle engine.

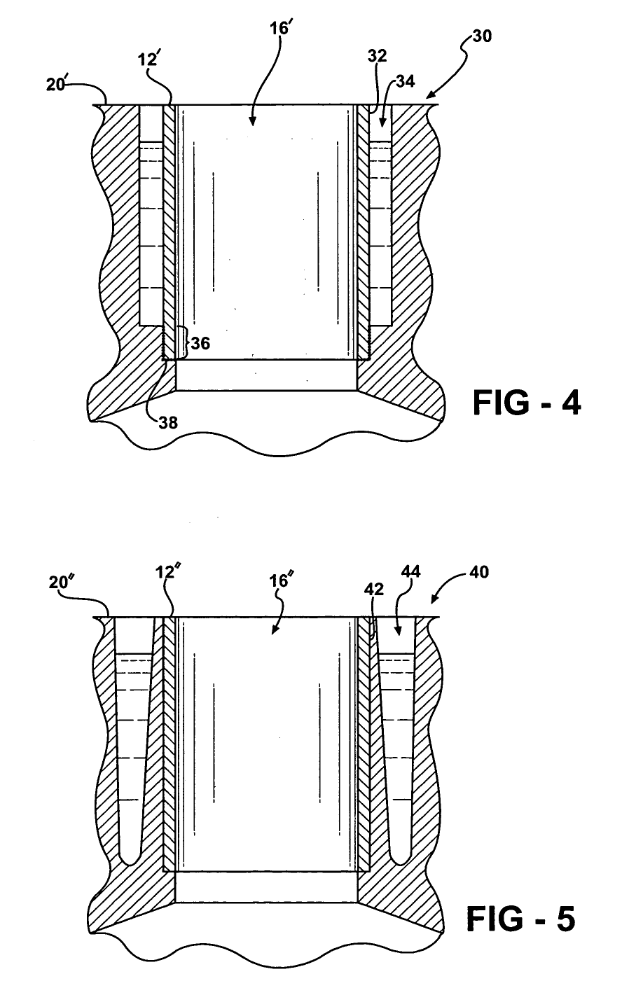

As is known, the engine cylinder block 20 includes numerous channels and flow passages for coolant flow formed therein. FIGS. 4 and 5 illustrate a wet type bore liner configuration 30 and a dry type bore liner configuration 40, both of which can be used with the invention as described herein. In the wet type bore liner configuration 30, an outer wall 32 of the bore liner 12′ forms an inner wall of a coolant passage 34 of the cylinder block 20′. A castover area 36 provides a seal between the aperture 16′ and the coolant passage 34. A sealing material 38 can also be disposed in the castover area 36, or other transition area between the aperture 16′ and the coolant passage 34. Any conventional sealing material which is capable of withstanding the heat generated in an engine cylinder block 20 during operation can be used as desired. It should be noted that the potential for a leak between the coolant passage 34 and the aperture 16 exists.

In the dry type bore liner configuration 40, an outer wall 42 of the bore line 12″ is cast into the engine cylinder block 20″. The coolant passage 44 is formed into the engine cylinder block 20″ adjacent the desired area to be cooled, but still maintaining a portion of the engine cylinder block between the outer wall 42 of the bore liner 12″. The dry type liner configuration 40 militates against the leaking of coolant into the aperture 16″ of the bore liner 12′. Although both the wet type bore liner configuration 30 and the dry type bore liner configuration 40 can be used with the present invention, more favorable results have been obtained using the dry type bore liner configuration 40.

The bore liner cassettes 10 of the present invention facilitate an alignment of the bore liners 12, and subsequently, the piston cylinders. Additionally, bore diameters can be maximized resulting in enhanced packaging and maximized displacement. Mass is also reduced, thereby maximizing fuel economy.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A cast-in-place cylinder bore liner cassette comprising:
at least one hollow cylinder bore liner adapted to be cast into an engine cylinder block to form a piston cylinder therein, an inner wall of said bore liner having a substantially circular cross section and a substantially uniform diameter, said cylinder bore liner formed from an aluminum alloy consisting essentially of, by weight,
less than 14% silicon;
about 2.0 to 2.5% copper;
about 0.25 to 0.35% magnesium;
about 0.4 to 0.5% iron;
about 0.5 to 0.73% manganese;
about 0.015 to 0.03% strontium;
about 0.1 to 0.25% titanium; and
a balance of aluminum, wherein the weight ratio of manganese to iron is about 1.25 to 1.45.

2. The bore liner cassette according to claim 1, wherein the aluminum alloy includes about 10.75 to 11.25% silicon by weight.

3. The bore liner cassette according to claim 1, wherein said cylinder bore liner is produced by high pressure die casting.

4. A cast-in-place cylinder bore liner cassette comprising:
a plurality of hollow cylinder bore liners joined at a bridge area, said bore liners adapted to be cast into an engine cylinder block to form a plurality of piston cylinders therein, an inner wall of each of said bore liners having a substantially circular cross section and a substantially uniform diameter, said cylinder bore liners formed from an aluminum alloy comprising, by weight,
less than 14% silicon;
about 2.0 to 2.5% copper;
about 0.25 to 0.35% magnesium;
about 0.4 to 0.5% iron;
about 0.5 to 0.73% manganese;
about 0.015 to 0.03% strontium;
about 0.1 to 0.25% titanium; and
a balance of aluminum, wherein the weight ratio of manganese to iron is about 1.25 to 1.45.

5. The bore liner cassette according to claim 4, wherein the aluminum alloy includes about 10.75 to 11.25% silicon by weight.

6. The bore liner cassette according to claim 4, wherein the aluminum alloy includes about 11% silicon by weight.

7. The bore liner cassette according to claim 4, further comprising up to 0.04% calcium by weight.

8. The bore liner cassette according to claim 4, further comprising up to 0.04% phosphorus by weight.

9. The bore liner cassette according to claim 4, wherein the aluminum alloy includes about 2.25% copper by weight.

10. The bore liner cassette according to claim 4, wherein the aluminum alloy includes about 0.3% magnesium by weight.

11. The bore liner cassette according to claim 4, wherein the aluminum alloy includes about 0.45% iron by weight.

12. The bore liner cassette according to claim 4, wherein the aluminum alloy includes about 0.058% manganese by weight.

13. The bore liner cassette according to claim 4, wherein the aluminum alloy includes about 0.022% strontium by weight.

14. The bore liner cassette according to claim 4, wherein the aluminum alloy includes about 0.15% titanium by weight.

15. The bore liner cassette according to claim 4, wherein longitudinal axes of said bore liners are substantially parallel.

16. The bore liner cassette according to claim 15, wherein the longitudinal axes of said bore liners are arranged substantially linearly in a transverse direction.

17. The bore liner cassette according to claim 4, wherein said cylinder bore liner is produced by high pressure die casting.

18. The bore liner cassette according to claim 4, wherein said cylinder bore liners are of a dry type bore liner configuration.

19. A method of forming a bore liner cassette for an engine cylinder block to form a plurality of piston cylinders therein, comprising the steps of:
providing an aluminum alloy comprising, by weight,
less than 14% silicon;
about 2.0 to 2.5% copper;
about 0.25 to 0.35% magnesium;
about 0.4 to 0.5% iron;
about 0.5 to 0.73% manganese;
about 0.015 to 0.03% strontium;
about 0.1 to 0.25% titanium; and
a balance of aluminum, wherein the weight ratio of manganese to iron is about 1.25 to 1.45; and
casting the cylinder bore liner cassette with the aluminum alloy, the bore liner cassette including a plurality of hollow cylinder bore liners joined at a bridge area, the bore liners adapted to be cast into an engine cylinder block to form a plurality of piston cylinders therein.

20. The method according to claim 19, wherein the casting step is high pressure die casting.
